(19) United States
(12) Patent Application Publication
(10) Pub. No.: US 2008/0120409 A1
(43) Pub. Date: May 22, 2008

(54) PRESENCE SERVICE SYSTEM AND METHOD FOR PUBLISHING PRESENCE INFORMATION

(75) Inventors: Qian SUN, Shenzhen (CN); Yang ZHAO, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 12/020,138

(22) Filed: Jan. 25, 2008

Related U.S. Application Data
(63) Continuation of application No. PCT/CN2006/001301, filed on Jun. 13, 2006.

(30) Foreign Application Priority Data
Jul. 29, 2005 (CN) 200510088746.3

(51) Int. Cl. G06F 15/173

(52) U.S. Cl. 709/224; 709/223

(57) ABSTRACT

A method for publishing presence information enables the presence information to be preset and published at a preset time automatically. The method includes the steps of: setting the presence information to be published, and setting the publishing time corresponding to each piece of the presence information to be published; when determining the publishing time arrives, the presence information corresponding to the publishing time is published

The present application is a continuation application of PCT application No. PCT/CN2006/001301, filed on Jun. 13, 2006, entitled “A PRESENCE SERVICE SYSTEM AND THE PRESENCE INFORMATION ISSUING METHOD”, which claims the Chinese priority No. 200510088746.3, filed Jul. 29, 2005.

### FIELD OF THE INVENTION

The present invention relates to Internet field and wireless communication field, particularly to a presence service system and a method for publishing presence information.

### BACKGROUND OF THE INVENTION

Presence service is a kind of communication service that is adapted to collect and publish presence information. Now, the presence service is usually provided in conjunction with instant message service. Of course, the presence service may be provided separately or in conjunction with other services, such as online games. International standardization organizations, such as Internet Engineering Task Force (IETF) and Open Mobile Alliance (OMA), have constituted specifications for presence service. Now, these specifications are being improved gradually. The presence information usually includes status information and communication address, etc.; for detailed content, reference may be made to the definitions in the standards, such as “A Model for Presence and Instant Messaging”, RFC 2778, published by IETF, but will not be detailed herein. In the present invention, the terminology provided in RFC 2778 will be used, that is, the object that provides presence information for the presence service is referred to as a presentity, and the object that requests for presence information in the presence service is referred to as a watcher. The users of presence service may be natural persons or non-natural persons, i.e., the presentity and the watcher may correspond to natural persons or non-natural persons.

At present, the application scope of presence service covers:

1. A natural person publishes his/her presence information. A natural person may publish his/her presence information via application program in a mobile telephone or a PC. For example, a user may publish information indicating that he/she is in a conference.

2. A non-natural person presentity publishes its presence information. For example, a radio station may publish the music track that is being played; a call center may publish the information on call congestion state.

3. Network elements may generate presence information about natural persons, for example, the information on whether a natural person has registered in the network.

4. Application servers and application programs are also presentities or watchers.

The networking diagram of a presence service system in the related art is shown in FIG. 1. It can be seen from FIG. 1 that the existing system includes the following.

A presence server, and, a presentity client and a watcher client which are connected to the presence server. The presentity client includes a presentity and a presence user agent. The watcher client includes a watcher and a watcher user agent.

The presence server transmits presence information between the presentity or watcher and the presence server via the presence protocol.

The presence user agent serves as a means that enables the presence user to interact with the system. The presentity publishes presence information to the presence server via the presence user agent.

The watcher user agent serves as a means to enable the watcher user to interact with the system. The watcher receives presence information from the presence server via the watcher user agent.

Based on the existing system, the presence information publishing process in the related art, as shown in FIG. 2, includes the following steps.

The operation from the presence user causes changes of the presence information. For example, a radio station changes the current program information; a user changes from offline state to online state when the user logs in to the system.

After recording the change of the presence information, the presentity client uploads the changed presence information to the presence server automatically.

The presence server updates, using the received presence information, the previously recorded presence information of the presentity.

The presence server sends the presence information to the watcher client according to the record of subscription for the presence information of the presentity from the watcher.

The watcher client updates, using the received presence information, the previously recorded presence information of the presentity.

As shown in FIG. 3, the presence information typically includes: status, such as information of Online, Offline, Busy, Idle, Leave, Do not Disturb, and in addition, location information which is also a sort of special status; communication address, which indicates address information of the presentity; and other symbols, which are designed to add new statuses or symbols.

The communication address further includes: contact method, which may be instant message, short message, etc.; contact address, which may be a user account (such as QQ number) and telephone number, etc.

Based on the existing presence service system, a non-natural person, such as a radio station, is unable to automatically publish preset presence information (program status) as scheduled. For a natural person, if his/her status in a period in the future is foreseeable, such as “Do not disturb” status, the status information can't be changed automatically at that time. In addition, for some presence information that changes cyclically, a natural person has to perform repetitive operations everyday to publish the presence information regular in time, such as daily rest, dining, attending class, and on duty, which is very inconvenient.

### SUMMARY OF THE INVENTION

To solve above technical problem, the present invention provides a presence service system, which may preset presence information and publish the presence information at scheduled time automatically.

The present invention further provides a method for publishing presence information, with which, presence information may be preset and published at scheduled time automatically.

The presence service system provided in the present invention includes:

a presence server, adapted to receive, store and send presence information;

a presentity client, adapted to publish the presence information of a presentity to the presence server;

a watcher client, adapted to receive the presence information sent by the presence server;

a recording module, adapted to record the presence information preset for the presentity and a corresponding publishing time;

a timing module, adapted to publish the corresponding presence information to the presence server according to the publishing time recorded in the recording module.

The recording module is set in the presentity client or presence server, or is a separate entity in the system; and, the timing module is set in the presentity client or presence server, or is a separate entity in the system.

The timing module sends the presence information corresponding to the publishing time that is recorded in the recording module to the corresponding presentity client; then, the presentity client publishes the received presence information to the presence server.

The presence information to be published that is recorded in the recording module is arranged in publishing time sequence.

The recording module is arranged in a World-Wide Web server, and the presence information preset for the presentity and the corresponding publishing time are set on World-Wide Web pages; or, the recording module is arranged in a short message application server, and the presence information preset for the presentity and the corresponding publishing time are set by means of a short message instruction.

The present invention further provides a presence service system, including:

a presence server, adapted to receive, store and send presence information;

a presentity client, adapted to publish the presence information of a presentity to the presence server;

a watcher client, adapted to receive the presence information sent by the presence server;

a timing module, adapted to record the presence information preset for the presentity and a corresponding publishing time, and publish the corresponding presence information to the presence server according to the recorded publishing time.

The timing module is set in the presentity client or the presence server, or is a separate entity in the system.

The timing module sends the presence information to the corresponding presentity client at the recorded publishing time first, and then the presentity client publishes the received presence information to the presence server.

The records in the timing module are arranged in publishing time sequence.

The timing module is arranged in a World-Wide Web server, and the presence information preset for the presentity and the corresponding publishing time are set on World-Wide Web pages; or, the timing module is arranged in a short message application server, and the presence information preset for the presentity and the corresponding publish time are set by means of a short message instruction.

In the present invention, the method for publishing presence information in presence service includes the following steps:

setting the presence information to be published and publishing time corresponding to each piece of the presence information; publishing the presence information corresponding to the publishing time when it is determined that the publishing time arrives.

The presence information corresponding to the publishing time is published through the following steps: receiving, by a presentity client, the corresponding presence information, and performing updating with the received presence information; uploading, by the presentity client, the updated presence information to a presence server; forwarding, by the presence server, the corresponding presence information according to a subscription record of a watcher.

The presence information corresponding to the publishing time is published through the following steps: directly receiving, by the presence server, the corresponding presence information, and forwarding the corresponding presence information according to the subscription record of the watcher.

A publishing target is set while the presence information to be published is being set; when it is determined that the publishing time arrives, the presence information corresponding to the publishing time is only published to the publishing target.

After the presence information to be published and the publishing time corresponding to each piece of the presence information are set, and when the presence server receives a query request for the presence information of a presentity from a watcher client, the presence server searches for the preset presence information and publishing time corresponding to a presentity ID according to the information of the presentity ID contained in the query request, and then returns a result of the query containing the preset presence information and publishing time and the current presence information of the presentity to the watcher client.

The presence information to be published and the publishing time corresponding to each piece of the presence information are recorded in publishing time sequence.

After the presence information corresponding to the publishing time is published when it is determined that the preset publishing time arrives, a sequence number of a record that is next to a record corresponding to the publishing time is stored; at next time for checking publishing time, the publishing time will be checked starting from the sequence number of the stored next record.

When the presence information corresponding to the current publishing time is published, the presence server sends, at the same time, preset presence information and publishing time corresponding to a time behind the current publishing time to the watcher client.

After the presence information to be published and the corresponding publishing time are set in advance, such preset presence information and corresponding publishing time are sent to the presence server immediately; the presence server sends the preset presence information and corresponding publishing time to the watcher client that has subscribed to the presence information of the presentity.

The present invention has the following beneficial effects.

In the present invention, a recording module is added to the existing presence service system to record the preset presence information and corresponding publishing time. In addition, a timing module is also added to the existing presence service system to control the preset presence information. When the publishing time arrives, the presence information corresponding to the publishing time will be published to the presence server, and then is forwarded by the presence server to the watcher client that has subscribed to the presence information. In that way, the function of publishing the presence information preset by the user as scheduled is implemented. Or, when the publishing time arrives, the presence information corresponding to the publishing time is sent to the presentity client, and then is published through the existing procedure in the related art.

With the above system and method, the user may set his/her presence information and the publishing time corresponding to the presence information according to his/her event scheduling in the future. In that way, when an event happens, the system may automatically change and publish the presence information of the user in accordance with the presetting by the user without the need of switching user status by the user. Therefore, the problem that the user has forgotten to update relevant presence information timely when the event happens, or that current presence information is not published because the user is in Offline status and doesn't start up the presentity client, may be avoided. In addition, for presence information that is changed cyclically, there is no need to perform repetitive operations everyday; instead, only set for one time, the presence information may be published automatically at the scheduled time everyday.

### BRIEF DESCRIPTION OF THE DRAWINGS

FIG. 1 is a networking diagram of a presence service system in the related art;

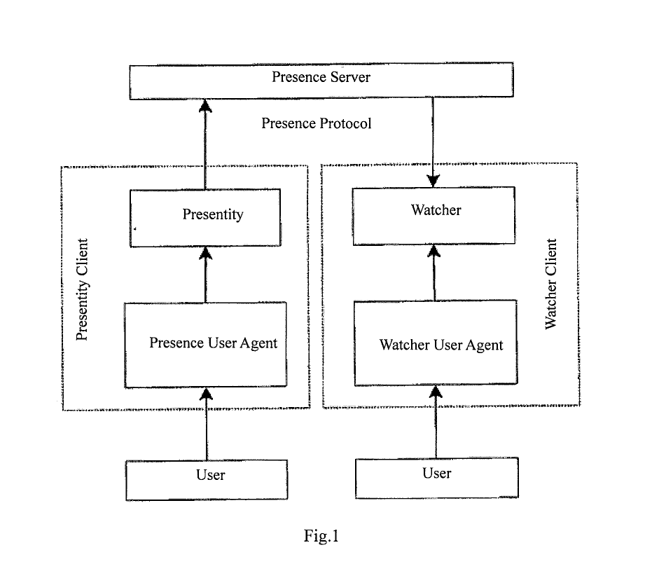

FIG. 2 is a flow diagram of publishing presence information in the related art;

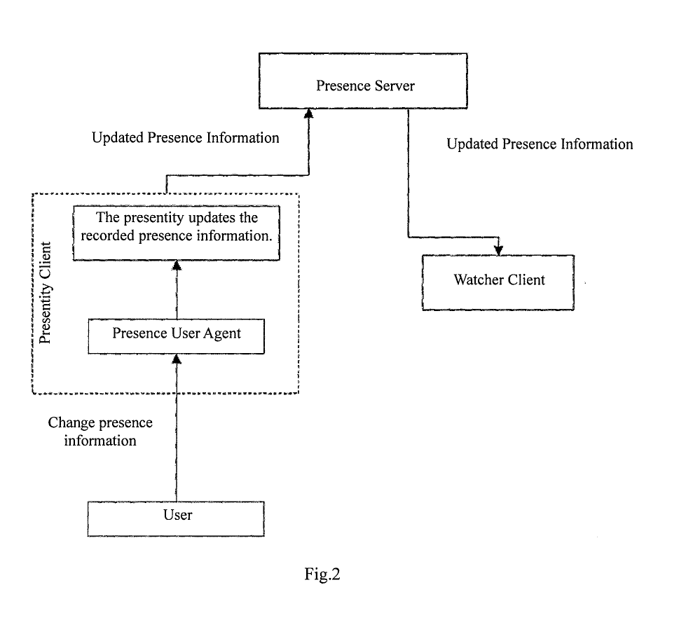

FIG. 3 is a structural diagram of the presence information;

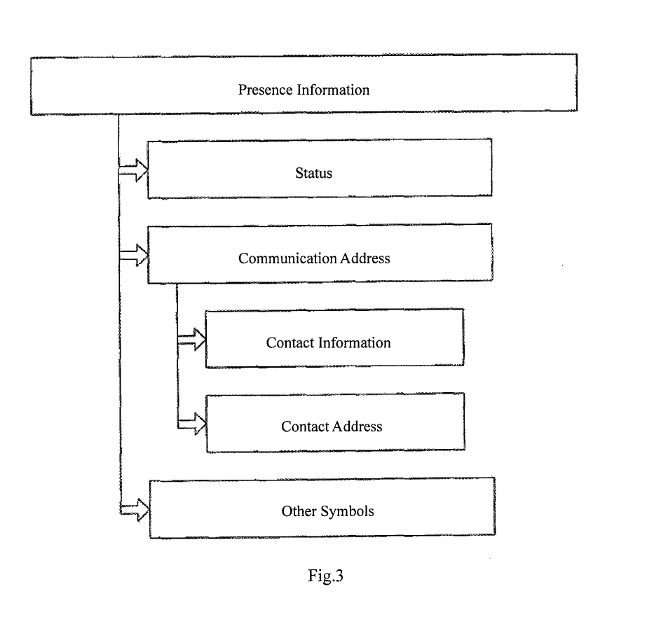

FIG. 4 is a networking diagram of a presence system with the modules provided in the present invention arranged with the presentity client;

FIG. 5 is a networking diagram of a presence system with the modules provided in the present invention arranged as separate entities;

FIG. 6 is a flow diagram of the procedures of the method provided in the present invention;

FIG. 7 is a message flow diagram of the method provided in the present invention.

### DETAILED DESCRIPTION OF THE EMBODIMENTS

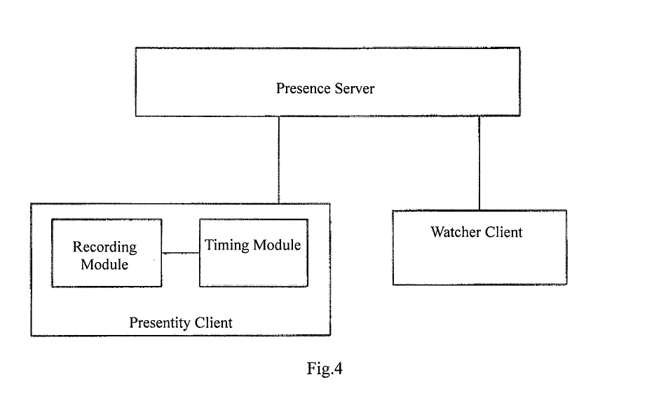

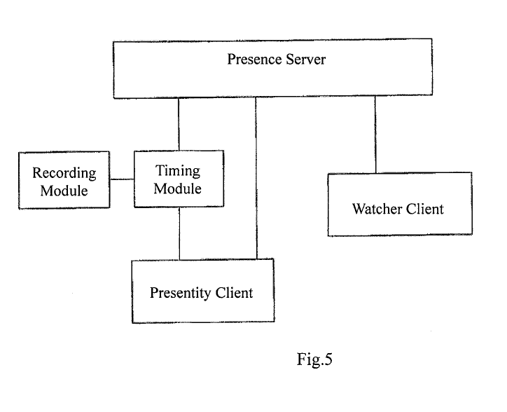

In order to enable a presence service system to publish presence information as scheduled, a recording module and a timing module are added to the existing presence service system in the present invention. As shown in FIG. 4 and FIG. 5, the system provided in the present invention includes the following.

A presence server, and, a presentity client and a watcher client which are connected to the presence server. In the presence server or presentity client, a recording module and a timing module are set. The recording module is connected with the timing module, and the timing module is connected with the presentity client, the presence server and the recording module. The recording module and the timing module may be separate entities in the system, with the connection relationship kept unchanged; the separate entities in the system refer to entities separated from the presentity client, the watcher client and the presence server.

The presentity client is adapted to upload the updated presence information of the presence user to the presence server via the presence protocol, whenever the presence information of presentity client is changed.

The watcher client is adapted to subscribe to or query for the presence information of the presentity, and receive the presence information that is sent, via the presence protocol, from the presence server.

The presence server is adapted to receive, via the presence protocol, the presence information sent from the presentity client, and publish the corresponding presence information of the presentity to the watcher client according to the presence information subscription record.

The recording module is adapted to record the presence information and corresponding publishing time preset by the user in a database or XML document. The timing module is adapted to publish the presence information automatically at the corresponding publishing time recorded in the recording module. The timing module may check whether the publishing time recorded in the recording module has arrived periodically, for example, once a minute. If the timing module determines that the publishing time has arrived, that is, the timing module compares the publishing time with the current time, if the time difference is smaller than a preset value, such as 1 minute, the timing module will obtain, from the recording module, the presence information corresponding to the record for which the publishing time arrives, and then publish the presence information corresponding to the publishing time to the presence server. In this method, the timing module needs to interact with the recording module frequently, therefore, it is recommended that the timing module and the recording module should be arranged in the presentity client together, or in the presence server together, or even, in a separate entity together; thereby, the interaction rate between the timing module and the recording module will be higher. The recording module may also be integrated into the timing module to form a single module, i.e. the timing module records the presence information and the corresponding publishing time preset by the user and then publishes the preset presence information at the preset publishing time.

The timing module may communicate with the presence server via XCAP protocol to publish the presence information. In addition, the timing module may update the presentity client with the presence information to be published in advance, and then the presentity client publishes the updated presence information to the presence server with the method in the related art. However, in this method, the presentity client is required to have been started up; otherwise, if the presentity client is not started up, for example, the user has shut down the presentity client, the preset presence information is unable to be published through this method.

The recording module may record the presence information and the corresponding publishing time preset by the user in the form of database records, as follows:

| | Presence | | |
|---|---|---|---|
| | Information | Presence | |
| Presentity ID | Symbol | Information Value | Publishing Time |
| 4985424 | Status | Do not disturb | 2005-7-25:12:00 |
| 4985424 | Status | Idle | 2005-7-25:14:00 |

Where, the presentity ID identifies a presentity uniquely, such as a QQ number, a telephone number, an e-mail address, an SIP address. The presence information symbol represents the type of the presence information, for example, status, communication address or any other extended presence information. The presence information value represents a value corresponding to the presence information symbol. The publishing time represents the preset publishing time for the presence information, which may be in Year-Month-Date: Hour: Minute format, and usually, minute-level accuracy is enough. In addition, the publishing time may also be in a relatively complex format, so as to express richer implication flexibly. For example, the publishing time may be an absolute time or a relative time. In the case of absolute time, a fixed time may be set directly; the relative time is a time that is after a certain time point by a time period. Absolute time may be in the following format: [Month/Date/Year] HH:MM, where, “[]” indicates optional; HH is a double-digit hour value, and MM is a double-digit minute value; if merely HH:MM is used, it indicates the presence information is published at HH:MM everyday cyclically. Relative time may be in the following format: absolute time+time period; the time period may be digit hours (or minutes, days, weeks).

The publishing time may also be in the following format: publishing start time ˜publishing end time; of course, it may include two fields, i.e. the publishing start time and the publishing end time. When the start time arrives, the corresponding presence information will be published; and when the publishing end time arrives, the corresponding presence information will be cleared, i.e. the presence information is updated by an idle value or a default value.

| | Presence | | |
|---|---|---|---|
| | Information | Presence | |
| Presentity ID | Symbol | Information Value | Publishing Time |
| 4985424 | Status | Do not disturb | 2005-7-25:12:00˜ |
| | | | 2005-7-25:14:00 |

Or:

| | Presence | Presence | | |
|---|---|---|---|---|
| Presentity | Information | Information | Publishing | Publishing |
| ID | Symbol | Value | Start Time | End Time |
| 4985424 | Status | Do not disturb | 2005-7-25:12:00 | 2005-7 |
| | | | | -25:14:00 |

Or, two records may be used to represent the publishing time, in which, one record indicates the publishing start time and the corresponding presence information value, while the other record indicates the publishing end time and the corresponding presence information value is idle or a default value. In that way, when the publishing end time arrives, the corresponding presence information may be cleared, that is, the presence information may be updated by an idle value or a default value. The corresponding two records are shown as follows:

| | Presence | | |
|---|---|---|---|
| | Information | Presence | |
| Presentity ID | Symbol | Information Value | Publishing Time |
| 4985424 | Status | Do not disturb | 2005-7-25:12:00 |
| 4985424 | Status | | 2005-7-25:14:00 |

The XML document format is similar to the content of 4985424.Xm1, with the presentity ID contained in the file name:

```
<?xml version=”1.0” encoding=”UTF-8”?>
<presence>
  <note1>
    <from>2005-4-12T10:00:00Z</from>
    <to>2005-4-12T12:00:00Z</to>
    <status>meeting with engineers from Cisco</status>
  </note1>
  <note2>
    <from>2005-4-12T16:00:00Z</from>
    <to>2005-4-12T16:20:00Z</to>
    <status>meeting with engineers from Nokia</status>
  </note2>
</presence>
```

Where, the value between <from> and </from> represents the publishing start time, while the value between <to> and </to> represents the publishing end time, and the value between <status> and </status> represents the presence information value.

The presence information and the corresponding publishing time may be preset in the recording module by means of WEB, WAP, short message or FTP, in which the presence information includes presence information symbol and presence information value. In the case of WEB or WAP method, the user may input the presence information and the corresponding publishing time on a webpage, and after the user submits the input, the CGI or ASP processing program corresponding to the webpage in the World-Wide Web server with the recording module will store the presence information, the publishing time and the presentity ID corresponding to the user into the recording module. Or, a short message instruction containing the presence information and the corresponding publishing time may be sent, in a predefined format, to an application server the recording module homes to via a short message center; then, the application server stores the presence information, the publishing time and the presentity ID corresponding to the user in the short message instruction into the recording module. Usually, the short message center stores a short message service number which corresponds to the address of above application server. Alternatively, an XML document containing the preset presence information and the corresponding publishing time may be edited on a computer terminal in advance, and then the XML document may be uploaded to the recording module by means of FTP.

In addition, sometimes the user may want to query or cancel the preset presence information or modify the publishing time for the presence information; such an operation may also be accomplished by means of WEB, WAP, short message or FTP. For example, to cancel the preset presence information via a short message, the user may send a short message instruction containing the presence information symbol to the application server the recording module homes to via a short message center; then, the application server deletes the record corresponding to the presentity ID (e.g., mobile telephone number or an ID with mapping relationship to the mobile telephone number) and the presence information symbol, according to the short message instruction.

In order to shorten the time required for checking whether the preset publishing time arrives and thereby improve system efficiency, the method for storing the preset presence information and publishing time may be optimized by storing the records in publishing time sequence. Whenever a record of preset presence information and publishing time is added into the recording module, the record is inserted to an appropriate position among the existing records in accordance with the publishing time. For example, the existing records may be sorted in publishing time sequence as follows:

| | Presence | | |
|---|---|---|---|
| | Information | Presence | |
| Presentity ID | Symbol | Information Value | Publishing Time |
| 3218767 | Status | Do not disturb | 12:00 |
| 3218767 | Status | | 13:00 |
| 4985424 | Status | Do not disturb | 2005-7-25:12:00 |
| 4985424 | Status | Idle | 2005-7-25:14:00 |

The sequencing method may be: periodic publishing times are sorted in time sequence and listed on top, followed by fixed publishing times sorted in time sequence, with the sequence number of the record corresponding to the first fixed publishing time stored. For example, as shown in the above table, the sequence number of the record corresponding to the first fixed publishing time is “3”, which indicates that the records corresponding to the fixed publishing times starts from row 3; or, periodic publishing times and fixed publishing times may be stored separately in two tables. In addition, after obtaining a record in which the publishing time has arrived, the timing module may store the sequence number of the record corresponding to the next periodic publishing time and the sequence number of the record corresponding to the next fixed publishing time, and thereby fast locating for the record corresponding to the publishing time that will arrive soon according to the above sequence numbers of the records can be implemented. If a record containing preset presence information and publishing time is added into the recording module and thereby the above sequence numbers of the records are changed, the sequence numbers of the records stored in the recording module should also be updated.

With the above system, the present invention allows a user to set the presence information to be published and the publishing time corresponding to each piece of the presence information. When the publishing time arrives, the presence information corresponding to the publishing time will be published automatically. A method for directly publishing presence information by a timing module to a presence server to accomplish publishing and a method for publishing presence information by a timing module to a presentity client first and then implementing a publishing through the existing procedure will be described.

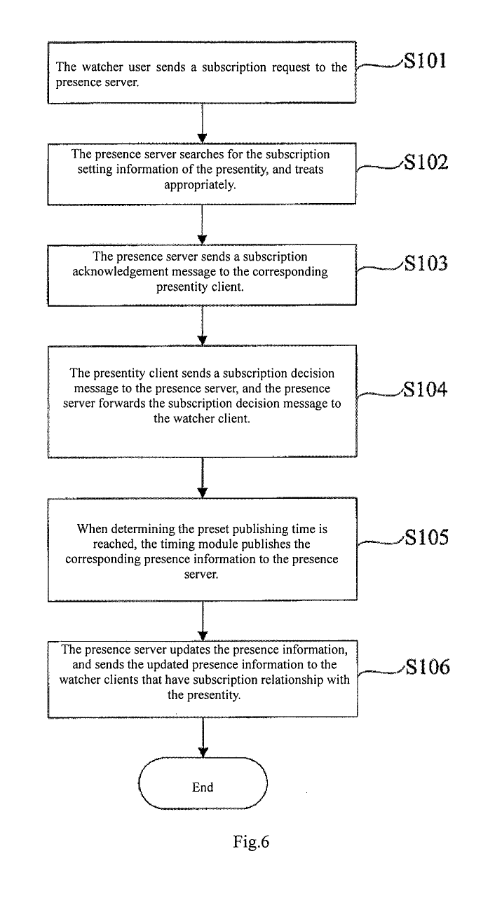

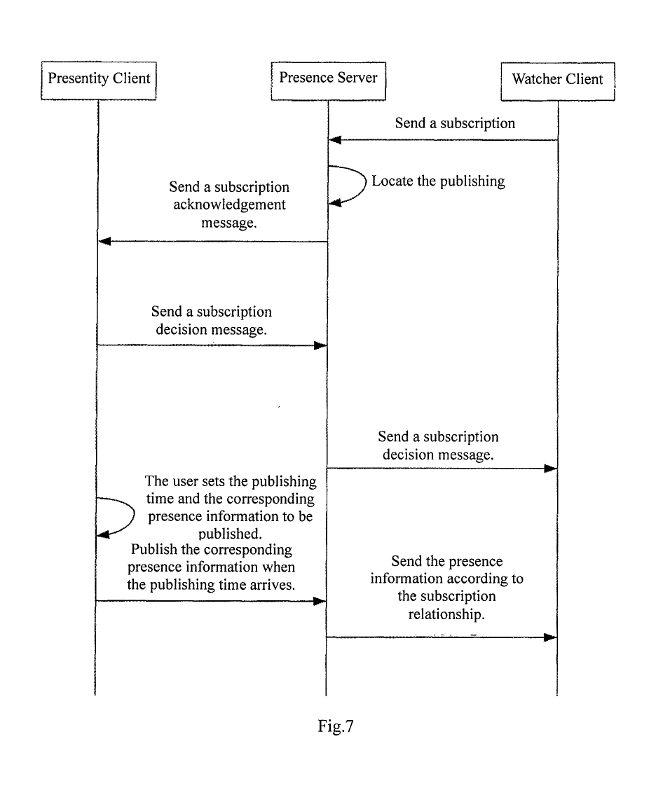

As shown in FIG. 6 and FIG. 7, the method for directly publishing presence information to the presence server to accomplish the publishing includes the following steps.

S101. A watcher user sends a subscription request to the presence server.

The watcher user sends the subscription request message via a watcher client to the presence server, with the presence information to be obtained by the watcher user and the corresponding presentity ID carried in the subscription request message.

S102. The presence server searches for the subscription setting information set by the presentity. If the subscription setting indicates a subscription without the need for acknowledgement from the presentity, the presence server will create a subscription record directly; otherwise the presence server sends a subscription acknowledgement message to the presentity.

S103. The presence server sends the subscription acknowledgement message to the corresponding presentity client.

S104. The presentity client sends a subscription decision message to the presence server; the presence server creates a subscription record, and forwards the subscription decision message to the watcher client.

S105. When determining the publishing time preset by the presence user arrives, the timing module publishes the presence information corresponding to the publishing time to the presence server.

S106. The presence server updates the presence information of the presentity, and sends the updated presence information to the watcher client that has subscription relationship with the presentity, according to the subscription record of presence information of the presentity.

If the watcher user obtains presence information by means of subscription, the presence server will publish the corresponding presence information automatically to the watcher client after the presence information of the presentity recorded in the presence server is updated. Alternatively, the presence information may not be sent to all watcher clients that subscribed to the presence information, because sometimes the presence user expects to publish the preset presence information only to certain watcher users; in the latter case, the following method may be used, that is, publishing targets are also set in the record containing the preset presence information and publishing time. A publishing target may be represented by a watcher ID, such as a QQ number, a telephone number or a SIP address, or may be represented by a Group ID set by the presence user, for example, Friend, Colleague or Stranger. Each group corresponds to several watcher IDs. A record containing publishing target is shown as follows:

| | Presence | Presence | | |
|---|---|---|---|---|
| Presentity | Information | Information | | Publishing |
| ID | Symbol | Value | Publishing Time | Target |
| 4985424 | Status | Do not disturb | 2005-7-25:12:00 | Stranger |
| 4985424 | Status | Idle | 2005-7-25:12:00 | 233333 |

Likewise, both the presence information of the presentity and the corresponding publishing targets are stored in the presence server. While publishing the presence information to the presence server, the timing module will store the corresponding publishing targets in the presence server, too. In that way, different preset presence information may be provided to different watchers.

Alternatively, when the presence information corresponding to the current publishing time is published, the presence server may send the preset presence information and publishing time corresponding to a time behind the current publishing time to the watcher client. That is to say, when publishing the presence information corresponding to the current publishing time to the presence server, the timing module also publishes the preset presence information and the publishing time corresponding to a time behind the current publishing time to the presence server; then, the watcher client receives and displays the current presence information of the presentity and the preset future presence information and corresponding publishing time. Another method is: after the presence information to be published in the future and the corresponding publishing time are preset, the recording module or the timing module sends the preset presence information and the corresponding publishing time immediately to the presence server; then, the presence server sends the preset presence information and the corresponding publishing time to the watcher user who subscribed to the presence information of the presentity. In that way, the watcher client may foresee the presentity's presence information to be published in the future in advance.

If the watcher user obtains the presence information by querying, then, only when the watcher user initiates a query request, the presence server sends relevant content of the presence information of the presentity in the current record to the watcher client according to the request of the watcher user. In addition, if the presence user expects that the watcher users may query the presence information preset by presence user, the following method may be used: when receiving a query request from a watcher client, the presence server searches in the recording module for the preset presence information and publishing time corresponding to the presentity ID contained in the query request, and returns the result of query and the current presence information of the presentity to the watcher client. In that way, the watcher user may foresee the presence information to be published in the future by the presentity.

Taking the following case for example, that is, the timing module is also used to record the presence information and the corresponding publishing time preset for the presentity and publishes the presence information at the preset publishing time, the method in which the timing module publishes the presence information to the presentity client and then the publishing is accomplished via the existing procedure includes the following steps.

The presence user sets the corresponding publishing time in the timing module for each piece of presence information to be published; when determining the publishing time arrives, the timing module sends to the presentity client the presence information corresponding to the publishing time, with which the presence information of the presentity that is recorded in the presentity client is updated; then, according to the existing procedure, the presentity client sends the updated presence information to the presence server.

Apparently, those skilled in the art may make a variety of modifications and alternations to the present invention, without departing from the spirit and scope of the present invention. If such modifications or alternations fall into the scope defined in the claims or any equivalent technical scope, the present invention intends to cover them.

1. A presence service system, comprising:
a presence server, adapted to communicate with a presentity client and a watcher client; wherein said presentity client publishes presence information of a presentity to the presence server; said watcher client receives the presence information sent by the presence server;
wherein the system further comprises:
a recording module, adapted to record the presence information preset by the presentity and a corresponding publishing time;
a timing module, adapted to publish the corresponding presence information to the presence server according to the publishing time recorded in the recording module.

2. The system according to claim 1, wherein the recording module is set in the presentity client or the presence server, or is a separate entity in the system; and, the timing module is set in the presentity client or the presence server, or is a separate entity in the system.

3. The system according to claim 1, wherein the timing module publishing the corresponding presence information to the presence server according to the publishing time recorded in the recording module comprises that
the timing module sends the presence information corresponding to the publishing time that is recorded in the recording module to the corresponding presentity client; and
the presentity client publishes the received presence information to the presence server.

4. The system according to claim 1, wherein the presence information to be published that is recorded in the recording module is arranged in publishing time.

5. The system according to claim 1, wherein the recording module is arranged in a World-Wide Web server, and the presence information preset for the presentity and the corresponding publishing time are set on World-Wide Web pages;
or, the recording module is arranged in a short message application server, and the presence information preset for the presentity and the corresponding publishing time are set by means of a short message instruction.

6. A method for publishing presence information in presence service, comprising:
obtaining the presence information to be published and publishing time corresponding to each piece of the presence information;
publishing the presence information corresponding to the publishing time when it is determined that the publishing time arrives.

7. The method according to claim 6, wherein the presence information corresponding to the publishing time is published through the following steps:
receiving, by a presentity client, the corresponding presence information, and performing updating with the received presence information;
uploading, by the presentity client, the updated presence information to a presence server; and
forwarding, by the presence server, the corresponding presence information according to a subscription record of a watcher.

8. The method according to claim 6, wherein the presence information corresponding to the publishing time is published through the following steps:
directly receiving, by the presence server, the corresponding presence information; and
forwarding the corresponding presence information according to the subscription record of the watcher.

9. The method according to claim 6, further comprising:
publishing, according to a preset publishing target, the presence information corresponding to the publishing time to the publishing target when the publishing time arrives.

10. The method according to any one of claims 6, further comprising:
receiving a query request for the presence information of a presentity, searching for the preset presence information and publishing time corresponding to a presentity ID according to the information of the presentity ID contained in the query request, and returning a result of the query containing the preset presence information and publishing time and the current presence information of the presentity.

11. The method according to claim 6, wherein the presence information to be published and the publishing time corresponding to each piece of the presence information are recorded in publishing time sequence.

12. The method according to claim 11, further comprising:
after the presence information corresponding to the publishing time is published when it is determined that the preset publishing time arrives, storing a sequence number of a record that is next to a record corresponding to the publishing time; at next time for checking publishing time, checking the publishing time starting from the sequence number of the stored next record.

13. The method according to claim 6, further comprising:
when the presence information corresponding to the current publishing time is published, sending, by the presence server, preset presence information and publishing time corresponding to a time behind the current publishing time to the watcher client.

14. The method according to claim 6, further comprising:
receiving the preset presence information and corresponding publishing time, after the presence information to be published and the corresponding publishing time are set in advance; and sending the preset presence information and corresponding publishing time to the watcher client that has subscribed to the presence information of the presentity.

15. A presence service system, comprising:
a presence server, adapted to communicate with a presentity client and a watcher client; wherein said presentity client publishes presence information of a presentity to the presence server; said watcher client receives the presence information sent by the presence server;
wherein the system further comprises:
a timing module, adapted to record the presence information preset for the presentity and a corresponding publishing time, and publish the corresponding presence information to the presence server according to the recorded publishing time.

16. The method according to claim 15, wherein the timing module is set in the presentity client or the presence server, or is a separate entity in the system.

17. The system according to claim 15, wherein the timing module publishing the corresponding presence information to the presence server according to the publishing time recorded in the recording module comprises:
the timing module sends the presence information corresponding to the publishing time that is recorded in the recording module to the corresponding presentity client;
the presentity client publishes the received presence information to the presence server.

18. The system according to claim 15, wherein the records in the timing module are arranged in publishing time sequence.

19. The system according to claim 15, wherein the timing module is arranged in a World-Wide Web server, and the presence information preset for the presentity and the corresponding publishing time are set on World-Wide Web pages;
or, the timing module is arranged in a short message application server, and the presence information preset for the presentity and the corresponding publish time are set by means of a short message instruction.

20. The system according to claim 3, wherein the presence information to be published that is recorded in the recording module is arranged in publishing time.

21. The system according to claim 3, wherein the recording module is arranged in a World-Wide Web server, and the presence information preset for the presentity and the corresponding publishing time are set on World-Wide Web pages;
or, the recording module is arranged in a short message application server, and the presence information preset for the presentity and the corresponding publishing time are set by means of a short message instruction.

22. The system according to claim 17, wherein the records in the timing module are arranged in publishing time sequence.

23. The system according to claim 17, wherein the timing module is arranged in a World-Wide Web server, and the presence information preset for the presentity and the corresponding publishing time are set on World-Wide Web pages;
or, the timing module is arranged in a short message application server, and the presence information preset for the presentity and the corresponding publish time are set by means of a short message instruction.
